(19) United States
(12) Patent Application Publication
(10) Pub. No.: US 2026/0225515 A1
(43) Pub. Date: Aug. 6, 2026

(54) METHOD FOR ADJUSTING A CONE OF LIGHT OF A LOW BEAM LIGHT OF A VEHICLE

(71) Applicant: Dr. Ing. h.c. F. Porsche Aktiengesellschaft, Stuttgart (DE)

(72) Inventors: Dominik Walter, Rutesheim (DE); Benjamin Hummel, Tamm (DE)

(73) Assignee: Dr. Ing. h.c. F. Porsche Aktiengesellschaft, Stuttgart (DE)

(21) Appl. No.: 19/461,030

(22) Filed: Jan. 27, 2026

(30) Foreign Application Priority Data
Jan. 31, 2025 (DE) 10 2025 103 564.4

(51) Int. Cl. B60Q 1/076

(52) U.S. Cl. CPC B60Q 1/076; B60Q 2300/45

(57) ABSTRACT

A method is provided for adjusting a light distribution of a light projector of a vehicle in an area in front of the vehicle. The cone of light illuminates a predetermined projection area, starting at a first point of contact, and extends to a predetermined end point. In the event that an area at a second distance in front of the vehicle is to be illuminated which is shorter than a predetermined first distance, a new point of contact is defined at the second distance and a headlamp range control of the vehicle is controlled in order to move the cone of light of the light distribution downwards in such a way that the first point of contact is shifted to the second distance, and simultaneously the image position of the low light beam is shifted upwards in order to maintain the end point.

### CROSS-REFERENCE TO RELATED APPLICATION

This application claims priority to German Patent Application No. 10 2025 103 564.4, filed January 31, 2025, the content of such application being incorporated by reference herein in its entirety.

### FIELD OF THE INVENTION

The present invention relates to a method for the projection of a cone of light into the environment of a vehicle.

### BACKGROUND OF THE INVENTION

Headlights installed in the front of vehicles are subject to regulations regarding the area in front of the vehicle that they illuminate. This light used to illuminate the road is also referred to as a low beam light. It must be set so that it illuminates the area in front of the vehicle without blinding other road users.

The ability to adjust the height of the low beam light relative to the horizontal is well known. This adjustment option is necessary in order to be able to manually or automatically adjust the emitted cone of light if the cone of light is not in a prescribed or optimal range. For example, a use of an inclination sensor to determine the inclination of the light module and thus the radiated cone of light towards the horizontal is known from DE 102008003707 A1, which is incorporated by reference herein, and to correct an adjustment of the inclination of the light module based thereon. An adjustment of the orientation of the light emissions of a headlight is also disclosed, e.g., from EP 3 489 084 A1, which is incorporated by reference herein.

In various situations, e.g., coming/leaving home, parking, displaying icons in front of the vehicle, etc., it is desired to display a projection in an area just in front of the vehicle so that the user can see the projection as optimally as possible. Such an area is a few meters in front of the vehicle, for example. A headlight unit comprising a headlight module for providing a base light function, e.g., the low beam light, and a light projector for providing projections such as symbols on the road is known from EP 4397543 A1, which is incorporated by reference herein.

By means of the headlight range control, there is alternatively the option of moving the headlights downwards in the above-mentioned situations and thus lowering the low beam light. However, this is not readily possible in the public traffic space, since the method involves pushing the entire cone of light downwards, and thus under certain circumstances the (legally) prescribed light values (horizontal orientation, illumination distance, illumination intensity) are no longer met.

It would therefore be desirable to provide a light projection of the low beam light as close to the vehicle as possible without reducing the range of the low beam light.

### SUMMARY OF THE INVENTION

A method is provided for adjusting a light distribution of a vehicle light projector in an area in front of the vehicle, wherein the light projector has a plurality of rows and columns of light points, such as LEDs, and is set up in such a way that a first point of contact of a lower edge of a cone of light of the light distribution output by the light projector touches the road at a predetermined first distance from the vehicle and that the cone of light illuminates a predetermined projection area, starting at the first point of contact and extends to a predetermined end point, characterized in that an area at a second distance in front of the vehicle is to be illuminated which is shorter than the predetermined first distance, a new point of contact is defined at the second distance and a headlamp range control of the vehicle is activated in order to move the cone of light of the light distribution downwards in such a way that the first point of contact is shifted to the second distance, and simultaneously the image position of the dipped beam is shifted upwards in order to maintain the end point.

In one embodiment, it is provided that the image position of the low beam is shifted upward by activating light point rows that are above the light point rows that are used to illuminate the first point of contact.

In one embodiment, it is provided that the method of the cone of light and the activation of the light point rows is carried out such that as little movement as possible of the end point occurs.

In one embodiment, it is provided that the adjustment of the light distribution and the image position of the low beam light is carried out using an actuator motor, in particular a stepper motor.

In one embodiment, it is contemplated that lighting the area at a second distance in front of the vehicle comprises lighting and/or projecting information in that area.

A headlight system of a vehicle is provided for generating a light distribution in an area in front of the vehicle, comprising at least one left and one right headlight module in the front region of the vehicle, which are formed as light projectors with a plurality of light points arranged in rows and columns and are arranged respectively, emitting a light distribution into an area in front of the vehicle, as well as a controllable actuator motor per headlight module, which is at least configured to adjust the orientation of the cone of light output by the headlight module according to the method described.

In one embodiment, it is provided that each light projector is formed from a plurality of high resolution modules each having a plurality of light points.

In one embodiment, the headlight system further includes a control unit per headlight module adapted to control the headlight module to provide the low beam light and/or a projection onto an area in front of the vehicle.

Further, a vehicle comprising the headlight system is provided.

Further features and advantages of the invention can be found in the following description of the example embodiments of the invention with reference to the figures of the drawing and the claims. The individual features may each be realized individually, or in multiple combinations in any way in a variant of the invention.

### BRIEF DESCRIPTION OF THE DRAWINGS

Preferred embodiments of the invention will now be explained in further detail with reference to the accompanying figures.

FIG. 1 shows a light projection of the low beam light onto the road.

### DETAILED DESCRIPTION OF THE INVENTION

In the following descriptions of figures, the same elements or functions are provided with the same reference signs.

In current vehicles, high resolution projection headlights are installed that provide both the low beam light and projections of, for example, information in front of the vehicle. Thus, they serve to illuminate the area in front of the vehicle as well as to communicate with/between vehicle occupants and passersby. A left and a right headlight module in the front region of the vehicle are generally provided, which are opposite each other over the width of the front region and are respectively configured to emit light distribution into an area in front of the vehicle. The headlight modules are designed as a light projector, e.g., from high-resolution modules with a plurality of light points each, e.g., LEDs (LED = light emitting diode), which are arranged in several rows on top of each other and columns next to each other and can be individually controlled (activated). The control of the functions (light and/or projections) is carried out via one or more control units.

In order to provide the most optimal adjustment of the projection of the light distribution provided by the light projector, the headlight modules can be moved, e.g., by means of an actuator motor so that their inclination angle can be adjusted compared to the road. This may be necessary if the adjustment calibrated during the manufacture of the vehicle has changed, e.g., due to a high load in the rear region.

To project a light distribution on the road, for example to display symbols or to provide a homecoming function, separate light projectors are currently provided, for example. In order to provide a projection into an area immediately in front of the vehicle, a separate light projector must be provided up to now, as the standard setting for low beam light would not illuminate the area close to the vehicle. Alternatively, a projection may occur within the projection region of the low beam light but not closer to the vehicle. Thus, it is not possible to use the low beam light in order to illuminate or project an area close to the vehicle in the public traffic area, since lowering the low beam light also reduces its range. An area close to the vehicle means that the placement point of the cone of light for the near area on the vehicle has about half the distance or less than the point of contact to which the low beam light is set in normal operation, i.e., when used in the public traffic area.

A projection of a light distribution is to be understood as the way the light is distributed onto a projection surface, such as a road or in three-dimensional space. Light distribution therefore means the distribution of the headlight light of the low beam light for lighting the road without blinding oncoming traffic in particular. The term light distribution also refers to the distribution of the light with different brightness and color for the purpose of displaying symbols such as graphics on the road.

The movement of the headlight module to adjust the horizontal orientation of the light distribution in particular is generally carried out via an actuator motor in operative communication with the headlight module, e.g., embodied as a stepper motor. Thus, the cone of light can be precisely adjusted.

As already mentioned at the beginning, the low beam light (the position of the light projector) is to be adjusted by default to illuminate the area in front of the vehicle without blinding other road users. Currently, the point of contact of the cone of light on the road is set at approximately 14 m, depending on the height of the headlight on the vehicle. For low mounted headlights, the projection area begins earlier, but not substantially. The goal is to be able to illuminate an area close to the vehicle, e.g., from about a distance of 5 m in front of the vehicle, also in the public space with the available headlight modules formed as a light projector (to illuminate or provide a light projection). The value of approximately 5 m is selected by way of example only. It should be chosen such that an occupant in the front area has a good view of the projection area in the immediate area. The distance can thus also only be 2 m or 3 m.

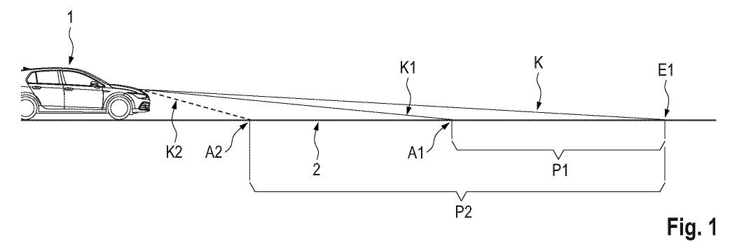

In FIG. 1, the projection area P1 illuminated by a headlight module (low beam light) is schematically indicated. It can be seen that the lower edge K1 of the cone of light of the light distribution is set so that it is placed on the road 2 in front of the vehicle 1 at the starting point A1 at a distance, which can be, for example, approximately 14 m. The upper edge K of the cone of light is set such that a (legally) specified projection area P1 is illuminated by the cone of light (from the point of contact A1 to the end point E1) without blinding other traffic users, in particular oncoming traffic. In order to provide the low beam light in accordance with the law, the light projector, which as described consists of a plurality of light points arranged in superimposed rows and columns, is mechanically set such that the point of contact A1 is illuminated by light point rows in the lower (near-road) area of the light projector. Overlying light point arrays illuminate the projection region P1 up to the end point E1. It is provided that further light point rows are available above the light point rows, which illuminate the end point E1, which are used, for example, to display the high beam.

A projection of information can thus far either occur within the projection region P1 if only a light projector is provided, which is to provide both the low beam light and the projection. Alternatively, a separate light projector is provided, which may also illuminate a closer area in front of the vehicle, in particular representing projections of information. However, it is not possible to cover both scenarios with only one light projector.

Also in FIG. 1, the light distribution transmitted by a light projector, which can represent both low beam light and a projection, is depicted at a significantly smaller distance from the vehicle 1, the point of contact A2 of the lower edge K2 of the cone of light. It can be seen that the upper edge K of the cone of light and thus the end point E1 remains unchanged, but the projection area P2 is enlarged towards the vehicle. This is achieved by simultaneously lowering the cone of light (the headlight range control moves downwards by means of a servomotor to illuminate the near range) and adjusting the image position for the low beam distribution in the light projector depending on the position of the headlight range control stepper motor, so that the end point E1 remains unchanged. Thus, the image position of the low beam light in the light projector is shifted upwards by controlling the light point rows as a function of the setting of the cone of light. This means that the lower rows of light points are no longer used to provide low beam lighting but are now free for projection. At the same time, light points in upper rows, which may otherwise be used for the use of the high beam, are controlled (activated) so that the end point E1 of the cone of light of the low beam remains unchanged and thus the legal requirements are met. Substantially, light point rows (which may otherwise be used to provide the high beam) located in the light projector (away from the road) are used to provide the low beam blind light when the headlamp level control slides the projector down (i.e., towards the road).

Advantageously, it is provided that the mechanical adjustment of the light projector and the change of the active light point rows is as simultaneous as possible, so that no abrupt movement of the cone of light is visible to the user. By synchronously controlling the mechanical movement and activating the light point rows, as little movement as possible of the end point E1 is achieved.

By adjusting the image position of the low beam light such that the upper edge K of the light distribution is not altered when the beamwidth control is lowered, a projection in the short range in front of the vehicle 1 is possible and at the same time the regular low beam position is maintained unchanged.

As already mentioned, the new point of contact A2 for the lower edge K2 of the light distribution can be provided at a significantly smaller distance to the vehicle than the previous point of contact A1. In particular, the new point of contact A2 may be placed at a distance in front of the vehicle 1 (in front of the vehicle 1) that is half or less than the previous point of contact A1. As already mentioned, the reduced distance should be selected such that a vehicle occupant can see the light projected onto the road, i.e., it is not obscured by the front of the vehicle.

What is claimed is:

1. A method for adjusting a light distribution of a vehicle light projector in an area in front of the vehicle, wherein the light projector has a plurality of rows and columns of light points that output light in such a way that a first point of contact (A1) of a lower edge (K1) of a cone of light of the light distribution output by the light projector touches a road at a predetermined first distance from the vehicle, and the cone of light illuminates a predetermined projection area (P1), starting at the first point of contact (A1) and extending to a predetermined end point (E1), the method comprising:
illuminating an area at a second distance in front of the vehicle which is shorter than the predetermined first distance by (i) defining a new point of contact (A2) at the second distance, and (ii) controlling a headlamp range control of the vehicle to move the cone of light of the light distribution downwards in such a way that the first point of contact (A1) is shifted to the second distance, and simultaneously an image position of a low beam light is shifted upwards in order to maintain the predetermined end point (E1).

2. The method according to claim 1, wherein the image position of the low beam light is shifted upward by activating light point rows that are above the light point rows that are used to illuminate the first point of contact (A1).

3. The method according to claim 2, wherein the activation of the light point rows is carried out to either limit or prevent movement of the end point (E1).

4. The method according to claim 1, wherein the adjustment of the light distribution and the image position of the low beam light is carried out using an actuator motor.

5. The method according to claim 4, wherein the actuator motor is a stepper motor.

6. The method according to claim 1, wherein lighting the area at the second distance in front of the vehicle comprises illuminating and/or projecting information in the area at the second distance.

7. A headlight system of a vehicle for providing a light distribution in an area in front of the vehicle, said headlight system comprising:
at least one left and one right headlight module in a front region of the vehicle, which headlight modules are formed as light projectors with a plurality of light points arranged in rows and columns and are arranged respectively, each headlight module emitting a light distribution into the area in front of the vehicle, each headlight module being configured to output light in such a way that a first point of contact (A1) of a lower edge (K1) of a cone of light of a light distribution output by the headlight module touches a road at a predetermined first distance from the vehicle, and the cone of light illuminates a predetermined projection area (P1), starting at the first point of contact (A1) and extending to a predetermined end point (E1); and
a controllable actuator motor assigned to each headlight module, each controllable actuator motor being configured to adjust an orientation of the cone of light output by the respective headlight module,
the headlight system being configured to illuminate an area at a second distance in front of the vehicle which is shorter than the predetermined first distance by (i) defining a new point of contact (A2) at the second distance, and (ii) controlling a headlamp range control of the headlight modules to move the cone of light of the light distribution downwards in such a way that the first point of contact (A1) is shifted to the second distance, and simultaneously an image position of a low beam light is shifted upwards in order to maintain the predetermined end point (E1).

8. The headlight system according to claim 7, wherein each light projector is formed from a plurality of high resolution modules each having a plurality of light points.

9. The headlight system according to claim 7, further comprising a control unit assigned to each headlight module, each control unit being adapted to control the headlight module to provide the low beam light and/or a projection onto the area in front of the vehicle.

10. A vehicle comprising the headlight system according to claim 7.
